(19) United States
(12) Patent Application Publication
(10) Pub. No.: US 2025/0225658 A1
(43) Pub. Date: Jul. 10, 2025

(54) METHOD AND APPARATUS FOR CHARACTERIZATION OF BREAST TISSUE USING MULTIPARAMETRIC MRI

(71) Applicants: Amy Heavner HERLIHY, Oxford (GB); Isobel GORDON, Oxford (GB); John Michael BRADY, Oxford (GB); PERSPECTUM LIMITED, Oxford (GB)

(72) Inventors: Amy Heavner HERLIHY, Oxford (GB); Isobel GORDON, Oxford (GB); John Michael BRADY, Oxford (GB)

(73) Assignee: PERSPECTUM LIMITED, Oxford (GB)

(21) Appl. No.: 18/869,127

(22) PCT Filed: Apr. 3, 2023
(86) PCT No.: PCT/EP2023/058670

§ 371 Date: Nov. 25, 2024

(30) Foreign Application Priority Data
Apr. 6, 2022 (GB) 2205048.8

(51) Int. Cl. G06T 7/00; G06T 7/11

(52) U.S. Cl. CPC G06T 7/0016; G06T 7/11; G06T 2207/10088; G06T 2207/30068

(57) ABSTRACT

A method and apparatus for analysing MRI data of breast tissue is described. The method comprising the steps of: acquiring a plurality of quantitative non-contrast MRI scan images of at least part of the breast area using different MR pulse sequences for each MRI scan image; determining a plurality of MRI metrics from the acquired quantitative MRI scans; using the determined metrics to generate a plurality of MRI metric maps; calculating at least one of: a breast composite map and a heterogeneity map, from the metric maps to show tissue characteristics of fat and non-fat tissue in the MRI image; determining breast tissue heterogeneity characteristics from at least one of the breast composite map and the heterogeneity map; and identifying clusters of data from at least one of the breast composite map, breast hetereogeneity map and the breast tissue hetereogeneity characteristics.

### FIELD OF THE INVENTION

This invention relates to the use of medical scan images, particularly MRI images for the analysis of breast tissue.

### BACKGROUND

Conventionally, the breast can be described as consisting of two main types of tissue; fatty tissue and fibrous, functional tissue. The breast can also contain abnormalities including cysts, fibroadenomas and various types of cancer. These abnormalities are typically found amongst the fibrous breast tissue. So-called “fatty” breasts have a low proportion of fibrous tissue compared to fatty tissue, whilst “dense” breasts have a high proportion of this fibrous tissue compared to breast fat. The term breast “fat” is a simplification to a substantial number of lipids including saturated, monounsaturated, and polyunsaturated types.

“Density” is a term that is used to refer to tissue that is mechanically dense and/or tissue that is radiologically dense in that it, for example in the case of mammography or tomosynthesis, attenuates x-rays substantially. Mammography, and increasingly Tomosynthesis, are the basis of screening of an asymptomatic population, generally women who are beyond, or going through, the menopause, women who we collectively refer to as “older” women. Mammographic screening has been shown to enable early detection of tumours in older women. The physical basis for mammography is that fibrous tissue undergoes involution to “fat” during the menopause, and fat is largely “transparent” (that is, has low attenuation) to x-rays. However, for a significant proportion of older women their breasts remain (radiologically) dense and for such women mammography and tomosynthesis are less informative. Mammography and tomosynthesis are far less informative for younger women whose breasts tend to be mechanically dense and this in turn makes the breasts radiologically dense. Breast (radiological) density has been shown to be a significant risk factor in predicting breast cancer.

Mammograms and Tomosynthesis volumes are often complex images that are challenging to assess and analyse by even experienced radiologists. For this reason, reporting and data standards have been developed, and continue to be revised and refined over time. Prominent among these are the BI-RADS (Breast Imaging Reporting and Data Standards) developed by the American College of Radiologists https://www.acr.org/Clinical-Resources/Reporting-and-Data-Systems/Bi-Rads. BI-RADS specifies a range of imaging modalities, including ultrasound, MRI, as well as mammography and tomosynthesis. Since mammography and tomosynthesis are the basis of population-based screening systems, and are relatively low-cost, the mammography and tomosynthesis part of the BI-RADS system is often used interchangeably with the entirety of BI-RADS. In mammography and tomosynthesis, a breast is classified into one of a number of BI-RADS classes, where, for example BI-RADS class 1 refers to a breast that is overwhelmingly composed of fatty tissue, and so is essentially transparent to X-rays. This means that it is generally straightforward to detect an isolated dense region such as a possible tumour in such a breast. Conversely, BI-RADS class 4 refers to a breast that is overwhelmingly composed of dense tissue, which makes the detection of a tumour in the breast far more difficult, rather like finding a snowball in a blizzard. Sometimes BI-RADS classes 1-4 are called A-D. Note that in general, BI-RADS identifies even more classes (for example 0-6); but the progression in the case of mammography and tomosynthesis is from overwhelmingly fatty, through scattered isolated dense regions, through primarily dense regions, through overwhelmingly dense. BI-RADS refers to the entire system of reporting and data standards, while an individual breast may be accorded a “score”, which means assignment to one of the classes. The best known “scoring” is for mammography and tomosynthesis, but there are scores also for other imaging modalities.

The breast parenchyma (the functional tissue as opposed to connective tissue) is typically highly heterogeneous. It is known that regional variations embody clinically significant information; for example, some local regions may correspond to abnormalities which could be benign or malignant. Equally, regional variation may convey information about breast cancer risk. Additionally, regional changes to breast tissue over time can indicate response to therapy, the development of pathology, or the reoccurrence of pathology. Finally, the amount and distribution of “dense” tissue can be used as one basis for assessing the risk of a woman developing breast cancer. Other bases for assessing risk include epidemiological factors (age, time of menarche, number of children, . . . ) and genetic and epigenetic factors such as mutations to certain genes (e.g. BRCA 1, 2) and/or the prior occurrence of breast cancer in near relatives.

Genomic and circulating biomarker data continues to play an important role in detecting and diagnosing breast disease. However, such data cannot convey information about regional information, which is why imaging that can provide phenotypical information about breast tissue is becoming increasingly important. Genetic profiling is typically used to establish the familial risk of breast disease. Such risk calculation can be improved with a combination of genetic profiling and phenotype classification.

Though prototype CT systems have been developed by academic groups, as noted above X-ray imaging has been overwhelmingly mammography (2D) and tomosynthesis (3D) which have considerably lower dose of x-rays at lower energies. These have had proven utility in post-menopausal women and are the basis of asymptomatic screening programs in many nations, including the United Kingdom. However, as explained above, the high X-ray attenuation of dense tissue has meant that mammography and tomosynthesis have not been shown to have clinical value for women with “dense” breasts. Having high breast density is the single largest risk factor for getting breast cancer in postmenopausal women. This means that for women with dense breasts, there is not only an increased risk of tumours being present, but also an increased risk that tumours would be missed. Most pre-menopausal women and around half of postmenopausal women are classed as having “dense” breasts, so mammography is not appropriate for a huge number of women. Ultrasound imaging is used in the breast, but this technique is limited in the information it can provide and has a high false positive rate. A variety of other imaging methods have been explored, including infrared and microwave, but these have not been demonstrated to have sufficient value to be used widely.

For pre-menopausal women, and for many post-menopausal women—especially but not only those with dense breasts—MRI offers many advantages. Unlike mammography/tomosynthesis, MRI enables visual examination of even the largest, most dense breasts without compression of the breast (which many women find painful or uncomfortable) and without the necessity for ionising radiation. Unlike mammography and tomosynthesis, MRI can be used equally for pre- and post-menopausal women and provides soft tissue contrasts that are clinically important. For these reasons, the use of MRI for breast imaging is increasing rapidly and it is widely regarded as the most advanced breast imaging modality. FIG. 1(a) shows an MRI image 50 of a breast, with a lymph node 51 highlighted in the image. FIG. 1(b) is an illustration of the regions of interest in a breast that will be imaged by MRI. This figure shows the breast tissue, breastbone, lymph nodes and secondarily the regions flanking the chest walls that include the axillae. The axillae are imaged primarily to determine whether or not a cancer has metastasized, since this has substantial impact on the subsequent treatment of the woman.

To date, there have been two major limitations of breast MRI. First, and of lesser importance, MRI is costly and imaging is more time consuming than mammography/tomosynthesis. Innovations in image reconstruction (e.g. compressed sensing) and improving coil and magnet designs are helping to address the cost of MRI, as is the development of “abbreviated” imaging protocols, which currently typically necessitate a 15 minute scan.

Second, and far more important, is the qualitative nature of conventional breast MRI. To appreciate this, consider briefly how an MRI image is formed. First, the patient is placed in a powerful magnetic field. In the case of breast MRI, the woman generally lies prone on the bed of the MRI machine with her breasts pendulous in a specialised breast receiver coil. Women find lying on their front with the breast coil pressing into their chest surrounding the breasts to be quite uncomfortable. They would prefer to lie on their back, though ordinarily the breasts fall back onto the surface of the chest, making imaging difficult.

Once the patient is in the MRI magnet in a suitable position (either prone or supine), radiofrequency energy at a certain frequency (RF) is radiated to the patient. This causes some protons in the tissue that is being imaged to change their spin state. A short time after the RF energy is stopped the protons in the imaged tissue relax back to their previous state. The ways in which they do this can be measured and are characteristic of the tissue in which the proton resides. There are several parameters associated with MRI, but the two most important have the dimensions of time and are denoted by T₁ and T₂ (or, in many cases a variant T₂*). Manufacturers of MRI equipment have developed a number of different pulse sequences each of which results in a (2D or 3D) image that emphasizes the contrast between certain important classes of tissue. For example, the brain consists largely of grey matter, white matter, and cerebrospinal fluid (CSF). According to the particular pulse sequence chosen the contrast between grey and white matter can be emphasised, or the CSF can be visualized. In current commercial practice, most pulse sequences result in images whose pixels (or voxels) confound the two basic measurements T₁ and T₂, generally with one of them, say T₁, predominating, in which case the image is said to be T₁-weighted. This means that the T₁ contrast is dominant but there is still impact from the T₂ contrast.

Even for the same woman, such mixtures of contrast vary from radiographer to radiographer as well as from machine to machine. These differences manifest as variations in image appearance and so this necessitates the radiographer mobilising their judgement and experience. As a result, inter- and intra-operator variability is high (it has been estimated around 30%). In particular, the appearance of abnormalities such as cysts, fibroadenomas and cancers varies considerably depending both on the woman's breasts and operational parameters chosen by the radiographer. It would be of considerable advantage if breast MRI could be made quantitative, since this would standardize images from radiographer to radiographer and machine to machine. This would mean, for example, developing pulse sequences that result in an image whose voxels are accurate measurements of (say) T₁ rather than being a confounded T₁-weighted mixture.

The difference between a weighted MRI image and a quantitative map is that the weighted images are simply images collected with a specific scan parameters to provide a given type of image contrast enabling clinicians to better visualize tissues. For quantitative maps, the tissue characteristic, such as T1 or T2, is calculated from a series of raw data scans. For example, a T2 weighted image will have a range of signal intensities where fluid will appear white while other tissues will appear darker. But a quantitive T2 map will show the calculated T2 value of the different tissues.

Current practice focuses only on detecting localised regions of abnormality that may correspond to a cancer. However, it has been found that often the contrast provided by conventional weighted sequences do not enable tumours to be detected, particularly when they are small. To this end, it is known that most cancers grow a chaotic, leaky vasculature through a process known as neoangiogenesis. Contrast agents, typically administered by injection, are based on large molecule paramagnetic lanthanide compounds (typically gadolinium chelates) that leak from the vasculature into the surrounding extravascular space, locally raising the MRI signal. Though attempts have been made to make the image processing of MRI contrast images quantitative, this is rarely, if ever, possible because the arterial input function that results from administering the contrast agent cannot in general be measured precisely. Also, many women find disturbing the sensation of contrast agent being taken up by the body and then, typically over 24 hours, being flushed out. Common side effects include nausea, headaches and dizziness. Gadolinium has also been shown to deposit in the brain, liver, skin and bone after use of these contrast agents, raising concerns about the safety of contrast-enhanced imaging.

This invention address problems discussed above with current MR imaging of breast tissue

### SUMMARY OF THE INVENTION

According to the invention there is provided a method of analysing MRI data of breast tissue comprising: acquiring a plurality of quantitative non-contrast MRI scan images of at least part of the breast area using different MR pulse sequences for each MRI scan image; determining a plurality of MRI metrics from the acquired quantitative MRI scans; using the determined metrics to generate a plurality of MRI metric maps; calculating at least one of: a breast composite map and a heterogeneity map from the metric maps to show tissue characteristics of fat and non-fat tissue in the MRI image; determining breast tissue heterogeneity characteristics from at least one of the breast composite map, and the heterogeneity map; and identifying clusters of data from at least one of the breast composite map, breast hetereogeneity map and the breast tissue hetereogeneity characteristics.

Further preferably, the clusters of data are contiguous clusters of data identified across one or more MR metrics.

Preferably, the breast composite map is compared against data from a patient database to identify the contiguous clusters of data. Further preferably, the data comparison allows identification of abnormal areas of breast tissue.

In an embodiment of the invention, the breast composite map is a 3D map where the contiguous clusters of data represent similar breast tissue. Further preferably, the breast composite map provides a spatial distribution of the dense breast tissue.

In an embodiment of the invention, the determination of breast tissue heterogeneity characteristics comprises the step of: determining one or more of: mean of the density of the pixels or voxels in the MRI scan, a chloropleth map showing the spatial distribution of a property, a texture map of the density.

Preferably, determining breast tissue heterogeneity characteristics including determining one or more of: fat content and breast composition; breast inflammation; and alteration of breast tissue structure.

Further preferably, the determined metrics generate an MRI map for each of the determined metrics. In an embodiment of the invention, at least two of the determined metrics are combined to generate a further metric map, and this further metric map is used in the calculation of the breast composite map.

Preferably, raw values for the at least two determined metrics are used to generate the further metric map.

In an embodiment of the invention, the MRI metrics comprise one or more of T1, corrected T1, T2, T2*, PDFF and ADC.

In a further preferred embodiment of the invention, the MRI metric map is a PDFF map or a corrected T1 map.

Preferably, the MRI scan are a 2D scans which produces a set of 2D images comprised of pixels, or 3D scans with a 3D image comprised of voxels.

Further preferably, at least one MRI metric is combined with one or more other MRI metrics, before generation of an additional MRI metric map which provides an improved estimate of the initial value of at least one MRI metric.

In an embodiment of the invention, the at least one metric is a T1 metric, and is combined with at least one of PDFF and T2*

In an embodiment of the invention, the method further comprising the step of generating at least one of the following MRI metric maps: T1 map, T2 map, T2* map, ADC map.

Preferably, the T1 metric is determined using a Modified Look Locker Inversion recovery sequence acquisition, shortened Modified Look Locker Inversion recovery sequence acquisition or a variable flip angle sequence acquisition. In an embodiment of the invention the T2* metric and/or the PDFF metric are determined using a multi echo gradient echo sequence acquisition. In a preferred embodiment of the invention the T2 metric is determined using a multi-contrast spin echo sequence acquisition.

Preferably, the ADC metric is determined using a single shot or multi-shot diffusion-weighted Echo Planar Imaging.

In a preferred embodiment of the invention the MRI scan is obtained with the patient in either the prone or supine position.

In an embodiment of the invention, the breast density map and the breast tissue characteristics are used to provide a disease risk score. Preferably, the disease risk score is a score related to BIRADS breast density classification.

In a preferred embodiment of the invention, the MRI images are acquired over a set time period to monitor changes in the breast density map and the breast tissue characteristics. Preferably, the set time period is a minimum of 1 week.

In an embodiment of the invention, the MRI scan is a scan of the entire breast area.

According to the invention there is also provided an apparatus for analysing MRI data from breast tissue to determine breast tissue heterogeneity characteristics from a breast density map, the apparatus comprising at least one processing component arranged to perform the method as described above.

Further preferably the at least one processing component of the apparatus for analysing MRI data comprises one or more of: one or more programmable components arranged to execute computer program code for performing one or more of the steps of the method above; and hardware circuitry arranged to perform one or more of the steps of the method described above.

Preferably, the apparatus further comprises at least one output component for outputting the breast density map, or determined breast tissue heterogeneity characteristics the at least one output component comprising one or more of: a display device for displaying the breast density map or determined breast tissue heterogeneity characteristics to a user; a data storage device for storing the breast density map or determined breast tissue heterogeneity characteristics; and an interface component for transmitting the breast density map or determined breast tissue heterogeneity characteristics to at least one external device.

### BRIEF DESCRIPTION OF THE FIGURES

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1(a) shows an example MRI image of breast tissue;

FIG. 1(b) is a schematic of a breast showing different tissue types;

FIG. 2(a) shows a flow diagram of a method according to an embodiment of the invention;

FIG. 2(b) shows the details of the analysis step in FIG. 2(a);

FIG. 3 shows the calculation of proton density fat fraction (PDFF) for breast tissue according to an embodiment of the invention;

FIG. 4 shows the calculation of quantitative breast density using breast PDFF maps according to an embodiment of the invention;

FIG. 5 shows the flow chart for a T1 map generated using a MOLLI or ShMOLLI MRI pulse sequence;

FIG. 6 shows a flow chart for a T1 map calculated using Variable Flip Angle (VFA) pulse sequence;

FIG. 7 shows a flow chart for a T2* map calculated using a multi-echo gradient method;

FIG. 8 shows a flow chart for a T2 map calculated using multi contrast spin echo pulse sequence;

FIG. 9 shows a flow chart for diffusion weighted EPI (echo planar imaging);

FIG. 10 shows various different breast density maps according to an embodiment of the invention

FIG. 11 shows a choropleth map of the brain.

### DETAILED DESCRIPTION

The present invention will now be described with reference to the accompanying drawings in which there is illustrated an example of a method and apparatus for characterization of breast tissue from medical imaging scan data. The method uses quantitative MR imaging, preferably, without requiring use of contrast agents. However, it will be appreciated that the present invention is not limited to the specific examples herein described and as illustrated in the accompanying drawings.

Furthermore, because the illustrated embodiments of the present invention may, for the most part, be implemented using components known to those skilled in the art, details will not be explained in any greater detail than that considered necessary as illustrated below, for the understanding and appreciation of the underlying concepts of the present invention and in order not to obfuscate or distract from the teachings of the present invention.

By using quantitative MRI methods, it is possible to measure different tissue metrics. Quantitative MRI methods have been used over the years to investigate tissue and disease states. In the early 1980s investigation of tissue characteristics such as T1 and T2 were important to help develop MRI methods that provided images with tissue contrast that highlights pathology. The original gold standard quantitative MR methods tend to take a long time and therefore are not appropriate for use in the clinical setting, as patients will not tolerate lying still for hours on end.

Improvements in both MRI hardware, computer systems and pulse sequences mean that there are now a variety of methods to quantitively measure tissue characteristics. The newer methods are fast, often meaning the images can be collected in a single breath-hold (a breath-hold scan). It should also be noted that multiple methods have been developed for measuring different MR tissue metrics. For example, the gold standard method for measuring T1 is called an inversion recovery spin echo pulse sequence. Collecting the information to calculate T1 with this pulse sequence can take several hours. Some of the newer methods of measuring T1 are MOLLI, (Modified Look-Locker Inversion Recovery) sh-MOLLI (shortened MOLLI) and Variable Flip Angle. These methods take under a minute for data collection, which make them clinically viable. It should also be noted that each of the faster methods have errors relative to the gold standard. For example, MOLLI T1 values will be consistently lower than the gold standard, and Variable Flip Angle methods are consistently higher.

As with T1, there are a variety of methods to measure other quantitative metrics. These methods are pulse sequences with defined scan settings which provide the data needed to calculate the desired metric. Data to calculate T2 typically requires the use of a pulse sequence that provides spin echo data. This could be one of many multi-contrast spin echo type pulse sequence. Conversely, data to calculate T2* typically requires the use of a multi-echo gradient echo pulse sequence. There are many variations of multi-echo gradient echo pulse sequences. A wide variety of these pulse sequences could be used to collect data to calculate T2*. Interestingly, the data required to calculate PDFF (proton density fat fraction) maps is also typically collected with a multi-echo gradient echo pulse sequence. However, the specific settings for this pulse sequence will change between the T2* data and the PDFF data. These are separate MRI scans, which use the same type of pulse sequence, but are run with different scan settings.

The same consideration applies to Apparent Diffusion Coefficient (ADC) maps, where the ADC parameter measures the magnitude of the diffusion of water molecules in a tissue. Changes in ADC are correlated with clinical deficits in tissue. The data required for an ADC map will require a pulse sequence to be set up to collect diffusion weighted data, but the specific pulse sequence might be a single shot or a multi shot diffusion weighted EPI (echo planar imaging), or even a different type of diffusion weighted scan that would provide the data needed to calculate ADC. The important point to realise is that data needed to generate quantitative maps can be collected with a variety of different pulse sequences. The pulse sequences and associated scan settings must be appropriate for the desired quantitative map.

It is also known that the newer faster quantitative MRI scanning methods may be impacted by confounding information from other tissue components. For example, by using MOLLI to measure T1 in an environment that has very short T2* characteristics (such as a liver with high iron) the resulting T1 values will be lower than if measured by a ground truth method. Techniques have been developed to correct for this bias in MOLLI T1 values for short T2* see for example, patent number GB2497668. Likewise, tissue with high fat content will have an impact on MOLLI T1 measurements. Care must be taken in collecting quantitative MRI metrics, ensuring that the clinically useful methods are implemented and ensuring that correction methods are applied where needed. Using existing tools for fast quantitative MR imaging and correction for confounders, it is possible to utilise quantitative imaging to characterise tissue in the clinic.

In normal practice each quantitative MR measurement is made on a pixel-by-pixel (2D scan) or voxel-by-voxel (3D scan) basis. If the data is regularised, then the metric can be improved to reduce factors such as noise. Standard image analysis tools can be used to ensure that quantitative parametric maps provide optimal estimates of the desired metrics.

The subject invention discloses a method of MRI imaging of the breast that can be used to determine breast tissue characteristics. The MRI imaging is quantitative MRI imaging. In a preferred embodiment of the invention, the MRI scan does not require the use of a contrast agent. A non-contrast MRI scan will be performed and the MR data will be used to generate one or more quantitative MR metric maps. These may include a PDFF map, a T1 map, a corrected T1 map. In further embodiments of the invention one of more of T1, a T2 map, a T2* map and/or an ADC map may also be generated. These MR metric maps are used to calculate one or more of breast density maps, breast composite maps and heterogeneity maps which will show tissue characteristics of fat and non-fat tissue in the MRI image. These quantitative MRI maps can then be used to characterize all or part of the breast tissue that has been imaged. Preferably breast tissue heterogeneity characteristics are determined from at least one of the breast composite map and the heterogeneity map, and clusters of data are identified from at least one of the breast composite map, breast hetereogeneity map and the breast tissue hetereogeneity characteristics. In a preferred embodiment of the invention the clusters of data are contiguous clusters identified across one or more MR metrics

The method of this invention can be used to provide assessment of breast tissue across the breast, identify abnormal areas in the parenchyma, and measure the change of the breast over time from the various maps and metrics that are produced. In a preferred embodiment of the invention, MRI images are acquired over a set time period to monitor changes in the breast composite map and the breast tissue characteristics. For example, to review changes in response to chemotherapy or radiotherapy, the breasts may be imaged weekly, however, it is also possible to do more long term monitoring of the breasts, where the breasts are imaged over longer intervals, such as periods of 3 months or more. The assessment may include an estimation of the risk of the woman subsequently developing breast cancer.

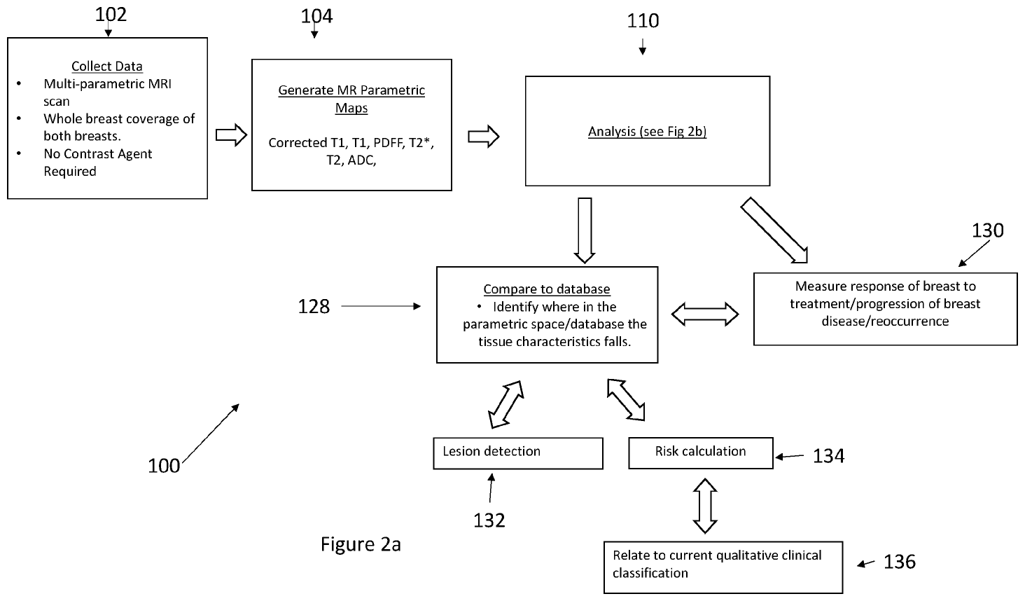

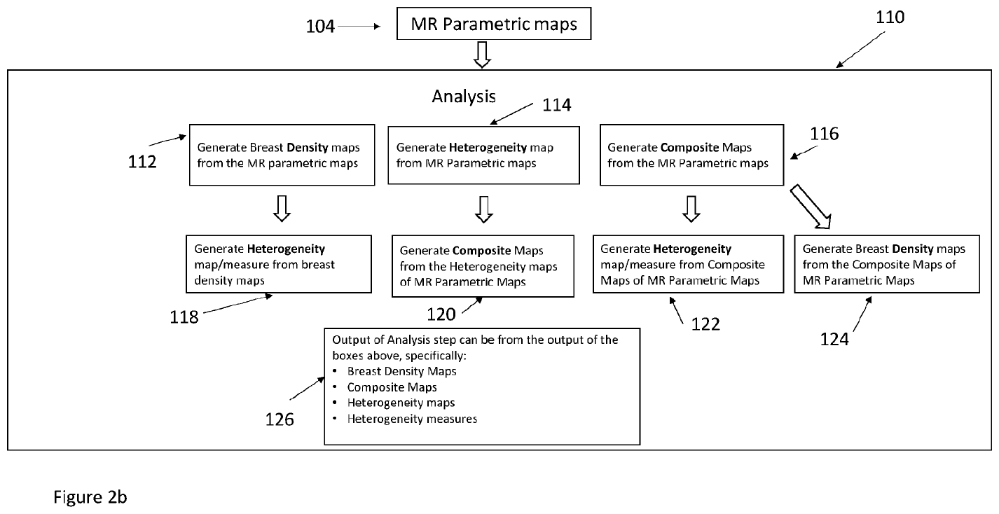

An overview of this method 100 is shown in FIG. 2(a). In a preferred embodiment of the invention, steps in this method include:

At step 102, an MRI scan is completed to provide multi-parametric data, preferably with whole breast coverage of both breasts, although the coverage may be one breast or a region of a single breast. The MRI scan is a quantitative scan, and in a preferred embodiment of the invention, the scan is performed without contrast agents. In an embodiment of the invention a a plurality of quantitative MRI scan images of at least part of the breast area are acquired using different MR pulse sequences for each MRI scan image The acquired MRI scans are either 2D scans which produces a set of 2D images comprised of pixels, or 3D scans with a 3D image comprised of voxels. A 2D scan will produce 2D maps, and a 3D scan will produce 3D maps.

In step 102 the MRI scan may be carried out either prone (with patient lying on their stomach and breasts dangling into breast receiver coil) or supine (with patient lying on their back and flex coil placed on top of breasts). Further details of these two scan methodologies are provided below. The methodology described below details the procedure for obtaining a scan of the entire breast area, but in some embodiments of the invention only a part of the breast area may be imaged, or only one of the breasts, or a part of only one of the breasts may be imaged.

### Prone Scans

i. Position patient in the breast RF coil, ensuring the breast tissue to be imaged is fully contained in the coil. Comfortable positioning also means ensuring the forehead is resting on the manufacturer's support device and the patient's arms are resting either in a “superman” position with the arms extending either side of the patients head, or resting at the side of the patient.
ii. All standard safety procedures will be followed and the patient will be given a device to notify the control room if there is a problem.
iii. The patient is advanced into the magnet to the scanning location.
iv. Localiser scans are collected, these are scans that allow the radiographer to locate the patient on the scan bed, so that more accurate data acquisition scans can be performed.
v. Non-quantitative volumetric scans are collected.
vi. a plurality of scans to generate quantitative maps are collected, corresponding to steps 102 described above.

### Supine Scans

i. Position patient supine on the scanner bed, with their head resting on a pillow. If any breast holding devices are being used, ensure they are being worn and are comfortable. Patient's arms should be in a comfortable position, typically at their side.
ii. Place the flex RF coil over the breasts (upper chest).
iii. All standard safety procedures will be followed and the patient will be given a device to notify the control room if there is a problem.
iv. The patient is advanced into the magnet to the scanning location.
v. Localiser scans are collected.
vi. Non-quantitative volumetric scans are collected.
vii. a plurality of scans to generate quantitative maps are collected, corresponding to steps 102 as described above.

Although the multi-parametric MRI scans maybe obtained with the patients in different positions, the analysis of the multi-parametric MRI scan data acquired for the different positions to determine MRI metric maps, breast density maps, breast composite maps, hetereogeneity maps and breast tissue heterogeneity characteristics will be the same.

Step 104 then generates one or more MR parametric maps from the one or more MRI metrics from MR scan data by using appropriate fitting algorithms. Preferably, the determined metrics are used to generate an MRI map for each of the determined metrics. The MR parametric maps may include one or more of T1, corrected T1, T2*, T2, PDFF and ADC. Step 110 is analysis of at least one of the MR metric maps to generate one or more of breast density maps, breast composite maps and heterogeneity maps, to show. tissue characteristics of fat and non-fat tissue in the MRI image As explained in more detail below the analysis is used to extract breast tissue density and multiparametric MR values of the parenchyma that can be used to determine breast tissue heterogeneity characteristics from at least one of the hetereogeneity map or the breast composite map, this is shown in more detail in FIG. 2(b). Additionally, heterogeneity measures of breast density and the MR parameters may be calculated at this stage.

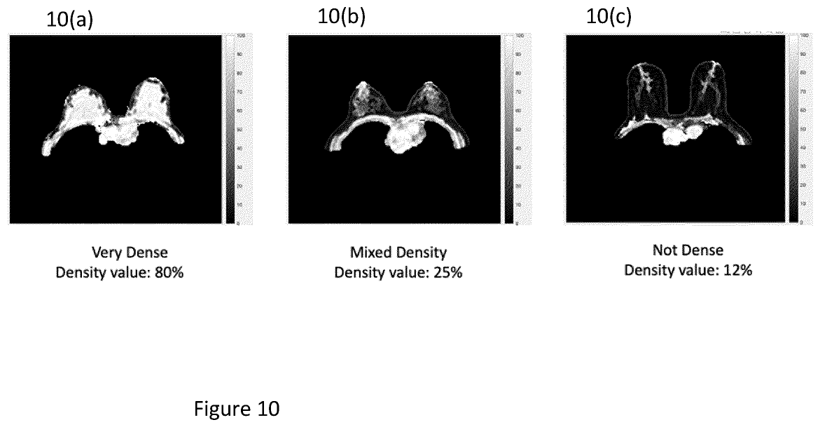

At step 110 the different MR parametric maps generated in step 104 are analysed in various different ways to generate different maps, which describe various tissue qualities, such as a breast composite maps and heterogeneity maps, which show tissue characteristics of fat and non-fat tissue in the MRI image. One example is a breast density map (such as shown in FIG. 10) which shows tissue of different densities in the breast that has been imaged. At step 112 breast density maps are generated from the MR parametric maps and these are subsequently used to generate a heterogeneity map from the breast density map (step 118). A heterogeneity MR map is a map that demonstrates how variable a given metric is over a given region. There can be different ways of measuring heterogeneity for example: mean of the density of the pixels or voxels in the MRI scan, a chloropleth map showing the spatial distribution of a property, a texture map of the density. It should also be noted that it is possible to assign a single measure of heterogeneity to spatial maps. This single heterogeneity measure may be calculated from the heterogeneity maps. As an example, the interquartile range of the values within the map might prove to be a useful measure of heterogeneity. An alternative step at 114 is to generate a heterogeneity map from the plurality of MR parametric maps. These are then used in step 120 to generate a breast composite map from the heterogeneity map derived from the MR metric maps. A composite MR parametric map is generated from a combination of 2 or more maps. An example of a composite maps is a corrected T1 map (where T1 is corrected for the iron or fat content of the tissue). Therefore a composite map shows a new MR parametric measure. A plethora of composite maps to characterise the tissue are possible. In the case of a composite heterogeneity map (as would be generated in step 120), the new metric could describe a measure of the combined heterogeneity of PDFF and T1 maps, which would provide a combined view of tissues of high water content (from T1 maps) and high fat content (from the PDFF map). This might aid in identifying patterns of cysts (high water content structures) with in fatty structures. In an embodiment of the invention, at least one MRI metric is combined with one or more other MRI metrics, before generation of an additional MRI metric map which provides an improved estimate of the initial value of at least one MRI metric. Preferably, the at least one metric is a T1 metric, and is combined with at least one of PDFF and T2*. Alternatively, from the MR parametrics maps generated in step 104, parameters can be used to generate a new composite map (step 116), for example a corrected T1 map where the T1 value is corrected for the fat or iron content in a tissue. These composite maps can then be used either to generate a heterogeneity map at 122, or to generate breast density maps from the composite maps 124. In general, the ability to combine various measures or combined measures of tissue characteristics is the outcome of step 110. All maps will aid in further characterizing breast tissue characteristics.

The output 126 from the analysis 110 may be one or more of the following: breast density map, a composite map, a heterogeneity map or a heterogeneity measure or breast tissue hetereogeneity characteristic. Following this, clusters of data are identified from at least one of the breast composite map, breast hetereogeneity map and the breast tissue hetereogeneity characteristics. In an embodiment of the invention the breast composite map is a 3D map where the contiguous clusters of data represent similar breast tissue. Preferably, the breast composite map provides a spatial distribution of the dense breast tissue.

In step 128 the analysis results from analysis step 110, that is one or more of breast density map, a composite map, a heterogeneity map or a heterogeneity measure are compared to a pre-existing database. This will identify where in the parametric space/database the tissue characteristic is located. Preferably, the database comparison will allow the identification of contiguous clusters of data. The comparison also allows for the identification of abnormal areas of breast tissue. Step 132 is for the detection of lesions in the breast tissue based on this comparison, step 134 is a calculation of the risk of breast cancer, step 136 relates the risk to current qualitative clinical classifications, and step 130 is to measure the response of breast tissue to treatment/progression of breast disease or recurrence.

In a preferred embodiment of the invention, the MRI scan volumes (either multi-slice 2D or 3D scans to produce 2D and 3D maps, respectively) to fully cover both breasts that are acquired at step 102, are collected for quantification of one or more of the following MRI parameters or metrics, as per step 104:
T1 metric using an MR pulse sequences such as Modified Look-Locker Inversion Recovery (MOLLI), sh-MOLLI and/or Variable Flip Angle method. A corrected T1 parameter can also be calculated from the raw T1 metric.
T2* metric using an MR pulse sequences such as a multi-echo gradient echo.
T2 metric using an MR pulse sequences such as a multi-contrast spin echo.
Proton Density Fat Fraction (PDFF) metric using MR pulse sequences such as a multi-echo gradient echo.
Apparent Diffusion Coefficient (ADC) metric using MR pulse sequences such as a single-shot or multi-shot diffusion weighted Echo Planar Imaging (EPI), this is a parameter which measures the magnitude of the diffusion of water molecules in a tissue.

The MRI metrics that are determined from the different pulse sequences described above are then used to generate a corresponding MRI metric map for each of the determined MRI metrics. In a preferred embodiment of the invention, the MRI metric maps are used for calculating at least one of: a breast composite map and a heterogeneity map, to show tissue characteristics of fat and non-fat tissue in the MRI image. Following this, breast tissue heterogeneity characteristics are determined from at least one of the breast composite map and the heterogeneity map; and clusters of data are identified from at least one of the breast composite map, breast hetereogeneity map and the breast tissue hetereogeneity characteristics.

Different MR pulse sequences to obtain different MR metrics, as mentioned in the descriptions of the scans above, may be utilised for different reasons. This may be to optimize tissue contrast whilst maintaining a clinically relevant scan time. The different MR pulse sequences may be performed in any order, and there may be specific operating protocols for different MRI scanner manufacturers, or other reasons for example, but the order of the MR pulse sequences is not important, merely the fact that a plurality of different MR pulse sequences are used. In an embodiment of the invention one or more MR pulse sequences may be used, and in further embodiments of the invention all of the different pulse sequences may be used to provided the MR metric from each different pulse sequence.

This is a brief overview of the different MR pulse sequences mentioned above:
Determination of a T1 map from a MOLLI pulse sequence (also ShMOLLI) is shown in FIG. 5.

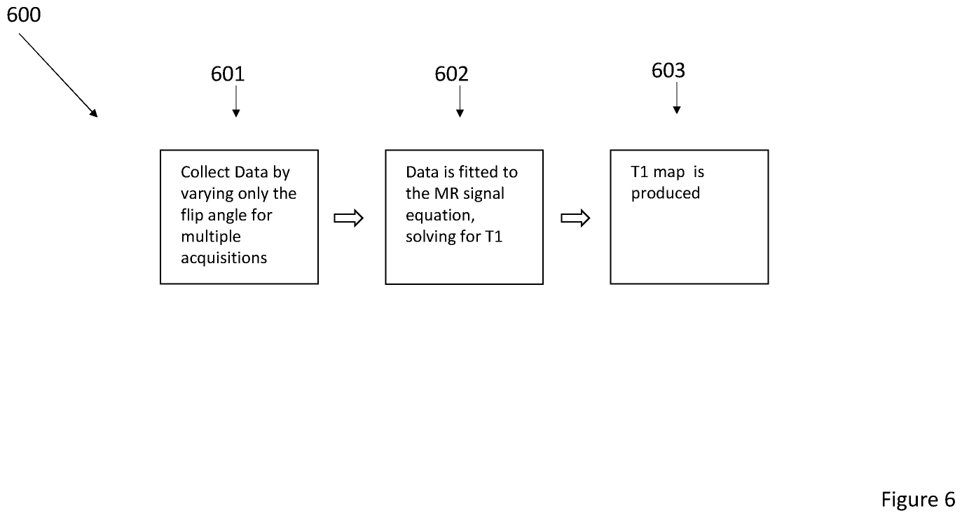

MOLLI (Modified Look-Locker Inversion recovery) is an inversion recovery pulse sequence 500 that collects data along the T1 recovery curve over 2 or 3 acquisition blocks. At step 501 MR data is collected. At step 502 the collected data is fitted to an inversion recovery T1 recovery curve. Finally at 503, the T1 metric map is produced. ShMOLLI (shortened) Modified Look-Locker Inversion recovery, follows the same general steps, just over a shorted time frame. Both of these sequences can be used for breath-hold scans, which reduces motion artefacts. They are very often used for cardiac T1 parametric scans.
The determination of a T1 map from a VFA pulse sequence 600 is shown in FIG. 6.

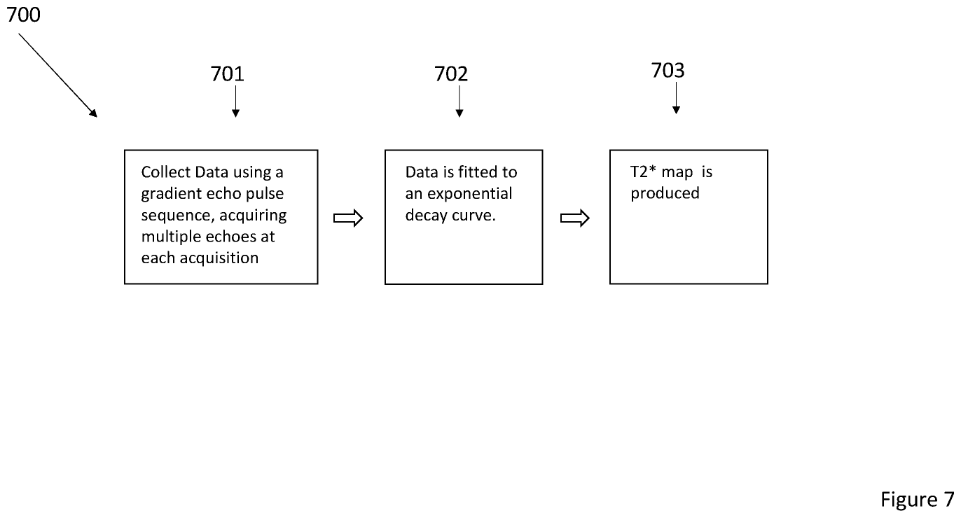

VFA (Variable Flip Angle) MRI scans are typically a series of short 3D gradient echo scans, where each MRI scan has as different flip angle. At step 601, data is collected by varying only the flip angle for multiple acquisitions, At step 602, the collected data is fitted to the MR signal equation, solving this for T1. Finally at step 603 the T1 metric map is produced. Gradient echo scans are typically short (for example 10-40 seconds is a usual scan time), which means VFA methods provides data to generate 3D T1 maps in a clinically useful time frame.
the determination of a T2* map using a multi-echo gradient echo pulse sequence 700 is shown in FIG. 7.

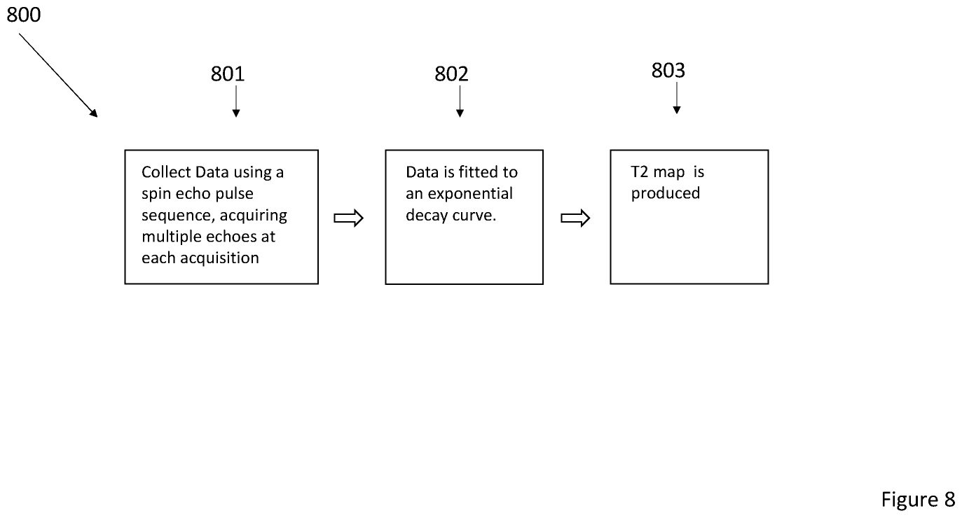

Multi-echo gradient echo sequences are gradient echo sequences that have been set up to acquire different echo times during a single MRI scan-rather than running multiple gradient echo scans, each with a different echo time. Using a multi-echo gradient echo provides a time efficient method for collecting scans with different echo times needed for generating parametric maps. Gradient echo sequences may be designed in such a way that the information they collect provides data to calculate T2* maps, which takes into account the magnetic field around the tissue structure. At step 701, data is collected using a gradient echo pulse sequence, acquiring multiple echoes at each acquisition, step 702 follows where the acquired data is fitted to an exponential decay curve. Finally, at step 703, a T2* map is produced. In an embodiment of the invention the PDFF parameter and metric map are determined using multi-echo gradient echo pulse sequence.
Determination of T2 map using Multi-contrast spin echo pulse sequence 800 is shown in FIG. 8.

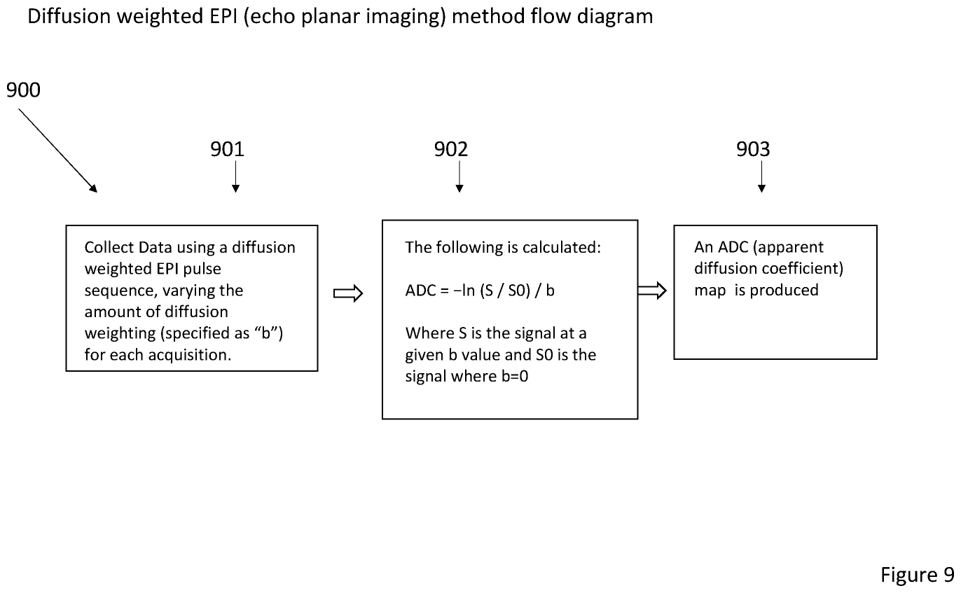

Multi-contrast spin echo sequences are spin echo sequences that are set up to acquire different echo times during a single MRI scan. As with the multi-echo gradient echo, this provides a time efficient method for collecting spin echo data with different echo times. Spin echo sequences designed in such a way that the information they collect provides data to calculate T2 maps. The magnetic field doesn't have an impact on these scans. Where T2 is a characteristic of the tissue, T2star is a characteristic of the tissue within its physical environment. At step 801 data is collected using a spin echo pulse sequence, acquiring multiple echoes at each acquisition. Step 802 follows where the acquired data is fitted to an exponential decay curve. Finally, at step 803, a T2 map is produced
Determination of apparent diffusion coefficient (ADC) map using Diffusion weighted EPI (echo planar imaging) pulse sequence 900 is shown in FIG. 9.

At step 901, Data is collected using a diffusion weighted EPI pulse sequence, varying the amount of diffusion weighting (specified as “b”) for each acquisition. Step 902 follows, where The following is calculated:

$$ADC = - ln ( S / S 0 ) / b$$

Where S is the signal at a given b value and S0 is the signal where b=0. Finally, in step 903, an ADC map is produced. Preferably, the ADC parameter is determined using a single shot or a multi shot diffusion weighted echo planar imaging. EPI pulse sequences are extremely fast scans that can take less than a second to acquire. The addition of diffusion weighting to a pulse sequence is an option that is very time consuming, such that diffusion weighting on spin echo scans, can mean the scans become too long for clinical use. Therefore, diffusion weighted scans tend to be based around EPI pulse sequences. The added diffusion weighting provides information, the value ADC (Apparent Diffusion Coefficient) related to how water molecules are diffusing in the tissue.

Some of the “raw values” of these MR parameters obtained by one or more of the MR pulse sequences outlined above may preferentially be combined with others to result in a closer estimate of the “true” value of the parameter. In an embodiment of the invention, at least two of the determined metrics are combined to generate a further metric map, and this further metric map is used in the calculation of the breast composite map. For example, the raw value of T₁ computed using (sh) MOLLI or VFA may be combined with an estimate of (proton density) fat (fraction) and/or T_{2*}. FIG. 5 shows a MOLLI/ShMOLLI flow chart. Data is collected at step 601, in a preferred embodiment of the invention, this pulse sequence samples the T1 curve by collecting with at least three sets of data over the T1 curve. ShMOLLI samples the T1 curve similarly, but with significantly shorter time scales and a reduced number of data points, enabling a shorter breath-hold MRI scan. Example scan times are 18 sec for a MOLLI scan and 9 seconds for a shMOLLI scan. At step 502 the acquired data is fitted to an inversion recovery T1 recovery curve, and at step 503, a T1 map is produced.

cT1 is a T1 measurement that is standardized for iron content in the liver and standardized across vendors and field strengths, and is described in GB2497668. The breast corrected T1 will be standardized across vendors and field strengths and corrected for fat content. In an embodiment of the invention, we will set up a standardization method by establishing a “ground truth” scanner system and then performing the quantitative scans across the scanner manufacturers (typically GE, Philips and Siemens) to generate a standardization table to map phantom data back to the values measured on the “ground truth” scanner.

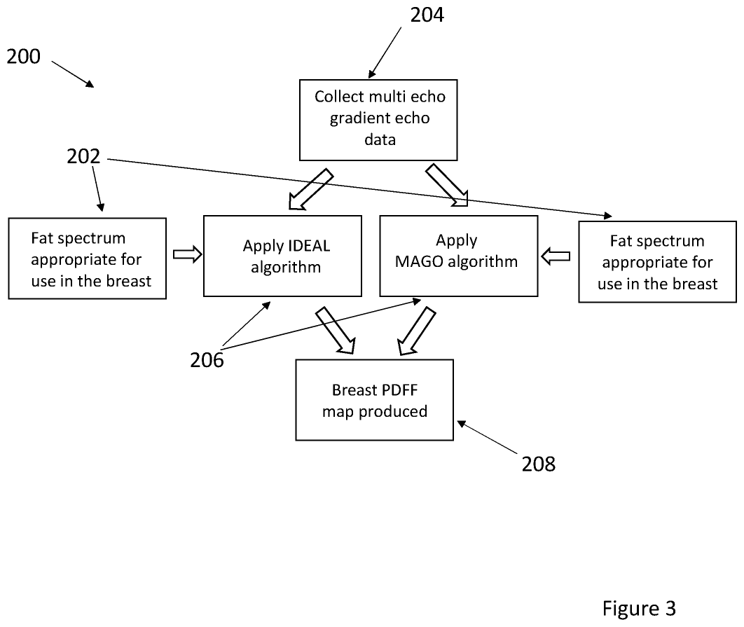

In an embodiment of the invention, the calculation of proton density fat fraction (PDFF) 200 from the scan data for the breast is performed using the steps shown in FIG. 3. A fat spectrum appropriate for use in the breast is used in step 202, and in a preferred embodiment of the invention, multi echo gradient echo MRI scans are acquired at step 204, although other pulse sequences may be used for other embodiments of the invention. The multi echo gradient echo data and the breast appropriate fat spectrum are provided as inputs to step 206 where an algorithm is applied to the input data. A variety of different algorithms are available to do this, including the IDEAL method (as described in U.S. Pat. No. 7,176,683) and the MAGO method (MAGO method as described in GB2576886). The PDFF measurement that results at step 208 provides an estimation of the amount of “fat” in each voxel of the MRI image. The calculation of PDFF typically requires a MR spectrum of the fat contained in the tissue being imaged, although other methods of determining PDFF may be used in alternative embodiments of the invention. The “fat” in the MR spectrum may be one particular species of lipid or represented as a summary of all different lipid types. An MR spectrum which is appropriate for use in the breast is used in conjunction with existing IDEAL or MAGO algorithms referenced above) to produce the PDFF measurement in each voxel. These algorithms use two species within a voxel (such as fat and water) to determine the relative signal contributions within that voxel, preferably by means of a cost function analysis method although other methods may also be used.

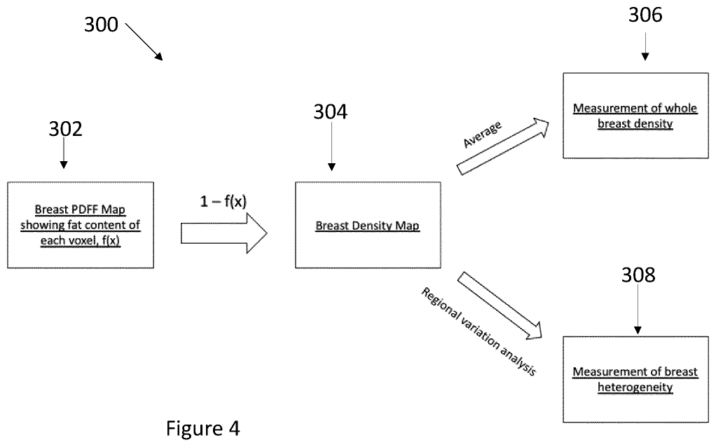

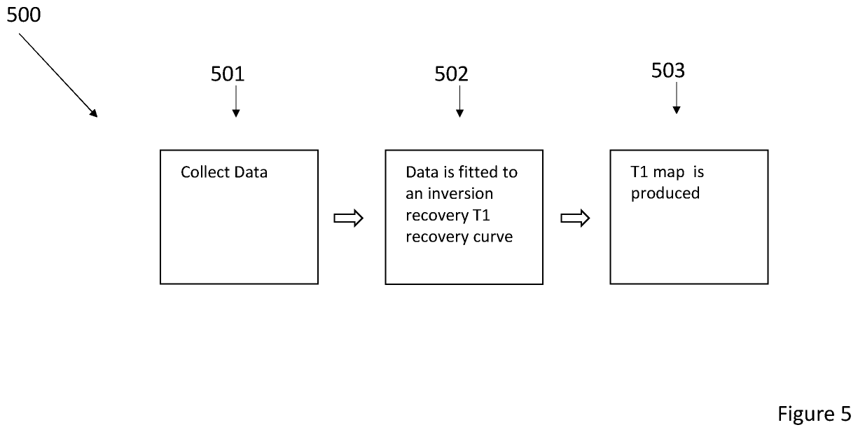

Calculation of quantitative breast density 300 using breast PDFF maps is shown in FIG. 4. At step 302 a breast density PDFF map is provided, using the method of FIG. 3 described above, showing the fat content of each voxel f(x). The density of a breast is based on how much fibroglandular tissue is present in the breast. By describing breast tissue as either fat or non-fat (which will be comprised of fibroglandular tissue and any lesions) then we can look at density as the amount of non-fat tissue that is present. So, if a voxel in the MR image represents 40% fat, then the remaining 60% of that voxel will be considered to represent non-fat or dense tissue. Therefore, a breast density map can be calculated from the PDFF map at step 304, where for voxel x the amount of fat tissue f(x) is known as a percentage, then the density (amount of non-fat) voxel can be estimated as 1−f(x). To calculate the density map, we will take the PDFF map, which expresses fat content in each voxel as a percentage, and by calculating 1 minus percentage fat, the density map will be calculated step 304. The density of the whole breast will be calculated as the average of all the density voxels in the breast at step 306. In a preferred embodiment of the invention, breast density will be measured both across the whole breast, and regionally to provide a determination or measurement of breast heterogeneity at step 308. In a preferred embodiment of the invention determination of breast tissue heterogeneity characteristics comprises the step of determining one or more of: mean of the density of the pixels or voxels in the MRI scan, a chloropleth map showing the spatial distribution of a property, such as the spatial distribution of dense breast tissue, a texture map of the density. In a further embodiment of the invention, determining breast tissue heterogeneity characteristics including determining one or more of: fat content and breast composition; breast inflammation; and alteration of breast tissue structure.

However, in some cases, the breast density as determined from the PDFF maps will be measured for only one breast, or for only part of a breast.

In an alternative embodiment of the invention, breast density may also be calculated from segmenting fibrous and fatty tissues according to their corrected T1 value and computing the relative amounts of each. In this case, we will know the total volume of the breast, having segmented the full breast tissue, then from the corrected T1 map, we will be able to distinguish fat from non-fat tissue using the value of corrected T1. In a further embodiment of the invention, these two alternatives, that is, estimating the fat fraction first, and estimating the dense tissue first, will be combined to yield the optimal compromise estimates of both.

For example, the corrected T1 parameter of breast fat is approximately 250 ms whereas the T1 parameter for non-fat tissue will be greater than 500 ms, as determined from preliminary experiments and also known from literature in this field. Having segmented the fat from the non-fat tissue, we can calculate the ratio of the volume of non-fat tissue to the volume of the whole breast. There are numerous freely available software packages to do this, such as ITK-Snap. This program uses a level set segmentation algorithm, widely used in medical imaging. The two breast density metrics can then be cross-validated by comparing the full breast density calculated using the PDFF map method to the full breast density using the corrected T1 volume method.

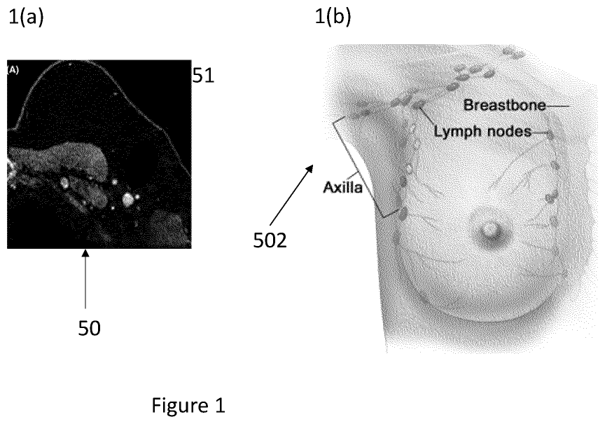

FIG. 10 shows various different breast density maps according to an embodiment of the invention. FIG. 10(a) shows breast tissue that is very dense with a calculated density of 80%, FIG. 10(b) show a mixed density breast with a calculated density of 25%, and FIG. 10(c) shows breast tissue that is classified as not dense, with a calculated density of 12%. We may relate these images back to FIG. 1 which showed the location of the breast axilla, and the location of lymph nodes within the axilla on an MRI scan. This demonstrates the utility of MRI scans which encompass the whole chest wall, providing visualization of lesions related to breast cancer, but not physically in the breast.

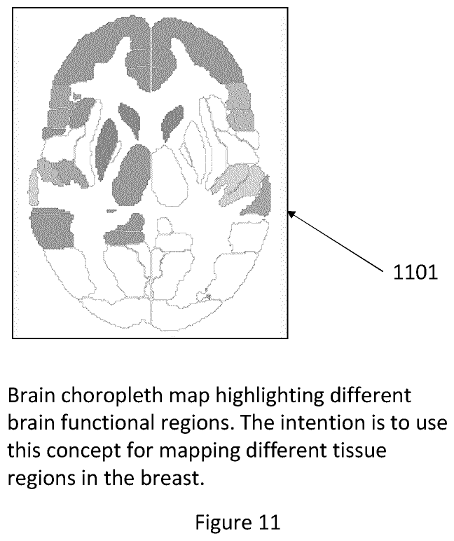

From a breast density map that has been produced in accordance with this invention (as described above and shown in FIG. 10) additional measures of breast tissue heterogeneity characteristics of the breast density will be calculated. These include but are not limited to: mean of the density of all of the pixels/voxels in the breast, choropleth maps, and texture maps of density. An example choropleth map for a brain in shown in FIG. 11. This is a map that shows a spatial distribution of a property. An example of the invention could be a map that shows all density that is above 70% dense tissue in one colour as well as density that is from 0-30% dense in another colour and above 30% but below 70% density in a third colour. Choropleth maps are typically be generated by grouping together pixels/voxels of similar characteristics to show spatial distribution. An example of a characteristic to map is all voxels of density above 70%. As well, spatial statistics will be generated from the dense breast data, for example to estimate the “scattered distribution” of dense tissue regions that is mention in some formulations of BI-RADS classes 2 and 3. Contiguous regions of dense tissue can be computed from the image using known methods including super-pixels and well-known methods of spatial statistics used to compute measurements of the spatial distribution of dense tissue within the breast. These measurements make precise the imprecise discussions of spatial distribution used in the descriptions of BI-RADS 2 and 3.

This invention also allows for the relation of quantitative breast density as determined above from breast density maps produced from the MRI metric maps, to current qualitative guidelines currently in use by clinicians, such as the BI-RADS density score. As we noted above, the BI-RADS score is used by clinicians to classify breast density into one of four categories (BI-RADS 1 to BI-RADS 4). These categories are used to influence the clinical pathway of the woman, determining what diagnostic procedures she may need for reliable identification of lesions. Unfortunately, the classification of women into these four categories has high inter-operator variability, particularly for the two middling classifications (BI-RADS-2 and BI-RADS-3). Through comparing to our database of patients, we will relate the calculated quantitative breast density metric to current BI-RADS density definitions to produce a BI-RADS density score which is not operator dependent.

An embodiment of this invention also allows for the use of multiparametric MRI to quantify the breast parenchyma. In addition to corrected T1, PDFF and breast density, additional parameters will be quantified in the breast including T2, T2*, and apparent diffusion coefficient (ADC). These additional parameters are calculated by processing MRI scan data with standard appropriate fitting algorithms, as illustrated in FIGS. 5 to 9. Together these parameters create a unique dataset for each patient. We then compare the patient's dataset against the parameter space of our full patient database to identify clusters of data. Preferably, the clusters are contiguous clusters of data.

This invention also allows for comparing one or more of the patient's multiparametric measurements obtained from the MRI data, against the location of these contiguous clusters in the parameter space to detect and classify abnormal regions (lesions) in the breast.

Comparing a patient's multiparametric MRI measurements against the location of these clusters in the parameter space to characterize breast tissue and provide assessment of breast health.

A further advantage of this invention is the use of multiparametric MRI measurements to measure changes in the breast parenchyma to map the response of the breast to treatment, the progression of breast disease and breast disease reoccurrence.

As described above, a multi-echo gradient echo pulse sequence is used to collect data appropriate for a MRI metric Map, preferably a PDFF map of the breast.

Using the data collected as described for the various different pulse sequences above, an MRI metric map, for example, a pixel/voxel-wise PDFF map of the breast is calculated. A variety of methods are available to do this, including the IDEAL method (as described in U.S. Pat. No. 7,176,683) and the MAGO method (as described in GB2576886)). An MR spectrum which is appropriate for use in the breast is used in conjunction with existing MAGO algorithms (as described in GB 2576886)) to produce the PDFF measurement in each voxel.

A breast density map is calculated from the PDFF map, where for voxel/pixel x the amount of fat tissue f(x) is known, then the density (amount of non-fat) can be estimated as 1−f(x). See FIG. 4.

The MRI data as acquired using the method described above can be used for calculating a metric of breast tissue density and associated characteristics.

The mean breast tissue density will be a specific value assigned to each breast, or part of a breast if only a part of the breast has been imaged. This breast tissue density is calculated as the average value of the density for all of the voxels (for a 3D scan image) or pixels (for a 2D scan image) within a breast. Texture maps of each breast (or part of a breast) will be generated using standard texture analysis methods currently available (for example entropy, standard deviation density functions as can be found in MATLAB).

From the breast tissue heterogeneity measures and MRI metric maps generated as described above, characteristics of breast tissue density, such as breast tissue heterogeneity characteristics including fat content, breast composition, alteration of breast tissue structure will be calculated.

From the collected breast tissue density and breast tissue heterogeneity metrics, a score that is related to the standard BIRADS breast density classification will be generated. In some embodiments of the invention the score will be a disease risk score.

For the case of 3D breast tissue density maps (generated as described above), the breast tissue density maps provide a measure of the density heterogeneity of the volume of the breast, not just a 3D representation of breast density.

As described with respect to FIG. 2, quantitative MRI Data required for generating one or more multiparametric maps of the breast (such as T1, corrected T1, PDFF, T2, T2* and ADC) is collected. Additionally, localizer scans and non-quantitative volumetric scans may also be collected for structural investigation and data overlay. The data acquired from the quantitative MRI scan is then processed as follows:

Using the quantitative MRI data collected in the previous step, pixel/voxel-wise MR metric maps (such as T1, corrected T1, PDFF, T2, T2* and ADC) are calculated. In an embodiment of the invention, the PDFF map is calculated through using a MR spectrum appropriate for use in the breast with the MAGO or IDEAL algorithm. T1, T2, T2* and ADC metrics are calculated by processing scan data with standard appropriate fitting algorithms. Corrected T1 would be standardized across scanner manufacturer and field strength and account for fat content in T1. These metrics can then be used for the generation of the corresponding MRI metric map.

The quantitative MRI metric maps will be used to determine breast tissue characteristics, in an embodiment of the invention this will include one or more of fat content and composition, inflammation, and alteration of breast tissue structure.

In an embodiment of the inventive the quantitative MRI metric maps will also be used to aid in lesion identification and characterization of the breast tissue by highlighting areas with abnormal MRI metric values.

By using one, or a combination of two or more of these MRI breast metric maps (such as T1, corrected T1, PDFF, T2, T2* ADC), metrics for breast health as well as breast tissue heterogenetenity will be calculated.

In an embodiment of the invention, breast health and tissue heterogeneity metrics may be based on a dictionary of both normal and abnormal tissue parametric values.

As described above, this invention provides a method for analysing MRI data from breast tissue to determine breast tissue heterogeneity In a further embodiment of the invention there is also provided an apparatus for analysing MRI data from breast tissue to determine breast tissue heterogeneity characteristics from a breast density map, the apparatus comprising at least one processing component arranged to perform the method of this invention. Preferably, the at least one processing component comprises one or more of: one or more programmable components arranged to execute computer program code for performing one or more of the steps of the method as previously described; and hardware circuitry arranged to perform one or more of the steps of the method as previously described. In a further preferred embodiment of the invention the apparatus may further comprises at least one output component for outputting the breast density map, or determined breast tissue heterogeneity characteristics the at least one output component comprising one or more of: a display device for displaying the breast density map or determined breast tissue heterogeneity characteristics to a user; a data storage device for storing the breast density map or determined breast tissue heterogeneity characteristics; and an interface component for transmitting the breast density map or determined breast tissue heterogeneity characteristics to at least one external device.

As described above, the invention may be implemented in a computer program for running on an image processing system, at least including code portions for performing steps of a method according to the invention when run on a programmable apparatus, such as an image processing system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a tangible and non-transitory computer readable storage medium or transmitted to the computer system via a computer readable transmission medium. All or some of the computer program may be provided on computer readable media permanently, removably or remotely coupled to an information processing system. The tangible and non-transitory computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of analysing MRI data of breast tissue, comprising:
acquiring a plurality of quantitative non-contrast MRI scan images of at least part of an area of the breast tissue using different MR pulse sequences for each MRI scan image;
determining a plurality of MRI metrics from the acquired quantitative MRI scans;
using the determined metrics to generate a plurality of MRI metric maps;
calculating at least one of a breast composite map and a heterogeneity map from the metric maps to show tissue characteristics of fat and non-fat tissue in the MRI image;
determining breast tissue heterogeneity characteristics from at least one of the breast composite map and the heterogeneity map; and
identifying clusters of data from at least one of the breast composite map, breast hetereogeneity map and the breast tissue hetereogeneity characteristics.

2. A method as claimed in claim 1, wherein the clusters of data are contiguous clusters identified across one or more MR metrics.

3-5. (canceled)

6. A method as claimed in claim 2, wherein the breast composite map is compared against data from a patient database to identify the contiguous clusters of data, the breast composite map is a 3D map where the contiguous clusters of data represent similar breast tissue, and the breast composite map provides a spatial distribution of the dense breast tissue.

7. A method as claimed in claim 1, wherein the determination of breast tissue heterogeneity characteristics comprises determining one or more of:
mean of the density of the pixels or voxels in the MRI scan;
a chloropleth map showing the spatial distribution of a property; and
a texture map of the density.

8. A method as claimed in claim 1, wherein determining breast tissue heterogeneity characteristics comprises determining one or more of:
fat content and breast composition;
breast inflammation; and
alteration of breast tissue structure.

9. (canceled)

10. A method as claimed in claim 1, wherein at least two of the determined metrics are combined to generate a further metric map, and this further metric map is used in the calculation of the breast composite map, and wherein raw values for the at least two determined metrics are used to generate the further metric map.

11. (canceled)

12. A method as claimed in claim 1, wherein the MRI metrics comprise one or more of T1, corrected T1, T2, T2*, PDFF and ADC.

13. A method as claimed in claim 1, wherein the MRI metric map is a PDFF map or a corrected T1 map.

14. (canceled)

15. A method as claimed in claim 1, wherein at least one MRI metric is combined with one or more other MRI metrics, before generation of an additional MRI metric map which provides an improved estimate of the initial value of at least one MRI metric.

16. A method as claimed in claim 15, wherein the at least one metric is a T1 metric, and is combined with at least one of PDFF and T2*.

17. A method as claimed in claim 1, further comprising:
generating at least one of the following MRI metric maps: a T1 map, a T2 map, a T2* map, and an ADC map.

18. A method as claimed in claim 1, wherein the T1 metric is determined using a Modified Look Locker Inversion recovery sequence acquisition, shortened Modified Look Locker Inversion recovery sequence acquisition or a variable flip angle sequence acquisition.

19. A method as claimed in claim 1, wherein the T2* metric and/or the PDFF metric are determined using a multi echo gradient echo sequence acquisition.

20. A method as claimed in claim 1, wherein the T2 metric is determined using a multi-contrast spin echo sequence acquisition.

21. A method as claimed in claim 1, wherein the ADC metric is determined using a single shot or multi-shot diffusion-weighted Echo Planar Imaging.

22. A method as claimed in claim 1, wherein the MRI scan is obtained with the patient in either the prone or supine position.

23. A method as claimed in claim 1, wherein the breast composite map and the breast tissue characteristics are used to provide a disease risk score.

24. (canceled)

25. A method as claimed in claim 1, wherein MRI images are acquired over a set time period to monitor changes in the breast composite map and the breast tissue characteristics, and wherein the set time period is a minimum of 1 week.

26-27. (canceled)

28. An apparatus for analysing MRI data from breast tissue to determine breast tissue heterogeneity characteristics from a breast composite map, the apparatus comprising at least one processing component arranged to perform the method of claim 1.

29. (canceled)

30. An apparatus as claimed in claim 28, wherein the apparatus further comprises at least one output component for outputting the breast composite map, or determined breast tissue heterogeneity characteristics,
wherein the at least one output component comprising one or more of:
a display device for displaying the breast composite map or determined breast tissue heterogeneity characteristics to a user;
a data storage device for storing the breast composite map or determined breast tissue heterogeneity characteristics; and
an interface component for transmitting the breast composite map or determined breast tissue heterogeneity characteristics to at least one external device.
